(19) United States
(12) Patent Application Publication
(10) Pub. No.: US 2009/0237201 A1
(43) Pub. Date: Sep. 24, 2009

(54) IMAGE PROCESSING APPARATUS, SETTING INFORMATION ACQUIRING METHOD, AND SETTING INFORMATION ACQUIRING PROGRAM

(75) Inventor: Toshiyuki Sato, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/388,044

(22) Filed: Feb. 18, 2009

Related U.S. Application Data
(60) Provisional application No. 61/032,378, filed on Feb. 28, 2008.

(51) Int. Cl. G05B 19/00

(52) U.S. Cl. 340/5.2

(57) ABSTRACT

To provide a technique for allowing a user to acquire information peculiar to the user stored in a storage area, for which log-in processing and authentication processing are necessary, through simple authentication processing using a card without performing operation for inputting a user ID and a password. An image processing apparatus includes: a card-ID-information acquiring unit that acquires card ID information of a user; a user-ID-information acquiring unit that outputs the card ID information acquired by the card-ID-information acquiring unit and acquires, according to the outputted card ID information, user ID information associated with the card ID information; and a setting-information acquiring unit that acquires, on the basis of the acquired user ID information, environment setting information concerning a work environment of the user corresponding to the user ID information, the setting-information acquiring unit acquiring the environment setting information on the basis of environment setting administrator authority for allowing the user to acquire a work environment associated with the user ID information of users who can be targets of acquisition of the work environment.

### CROSS-REFERENCE TO RELATED APPLICATION

This application is based upon and claims the benefit of priority from U.S. provisional application 61/032,378 filed on Feb. 28, 2008, the entire contents of which are incorporated herein by reference.

### TECHNICAL FIELD

The present invention relates to a setting information acquiring technique for a work environment peculiar to a user in a multi function peripheral (MFP) or the like, and, more particularly to an authentication method for acquiring setting information for a work environment using a card.

### BACKGROUND

In the past, a multi function peripheral (MFP) such as an image processing apparatus that has plural functions including printer, scanner, copying machine, and facsimile functions is used. The MFP is often used while being connected to a personal computer, a server, and the like via a network. Authentication processing and log-in processing are performed by using a user ID and a password in order to acquire information from the server and the like connected to the network and use a system established by the server and the like.

For example, in order to set a work environment peculiar to a user in the MFP, processing for logging in to a server in which setting information for specifying the work environment is stored and acquiring the setting information is performed. In the log-in, the user operates an operation input unit such as an input button to input the user ID and the password and is authenticated.

In this case, the user operation is complicated because the user has to input the user ID and the password every time the user logs in to the system. The input of the user ID and the password causes a fall in work efficiency.

Therefore, when authentication processing that requires a user to input information such as a user ID and a password in order to log in to a server and a system is performed, for example, when information for setting, for example, a work environment peculiar to the user in an MFP is acquired, there is a demand for a system that can easily perform the authentication processing without requiring the user to perform complicated operation such as the input of the user ID and the password.

### SUMMARY

It is an object of an embodiment of the present invention to provide a technique for allowing a user to acquire information peculiar to the user stored in a storage area, for which log-in processing and authentication processing are necessary, through simple authentication processing using a card without performing operation for inputting a user ID and a password.

In order to solve the problems, according to an aspect of the present invention, there is provided an image processing apparatus including: a card-ID-information acquiring unit that acquires card ID information of a user; a user-ID-information acquiring unit that acquires, on the basis of the card ID information acquired by the card-ID-information acquiring unit, user ID information for identifying the user associated with the card ID information; and a setting-information acquiring unit that acquires setting information concerning a work environment of the user corresponding to the user ID information, the setting-information acquiring unit acquiring, on the basis of administrator authority for allowing the user to acquire setting information associated with user ID information of plural users who can be targets of acquisition of the setting information, the setting information corresponding to the user ID information acquired by the user-ID-information acquiring unit.

According to another aspect of the present invention, there is provided a setting information acquiring method including: acquiring card ID information of a user; acquiring, on the basis of the acquired card ID information, user ID information for identifying the user associated with the card ID information; and acquiring, on the basis of administrator authority for allowing the user to acquire setting information associated with user ID information of plural users who can be targets of acquisition of setting information concerning a work environment of the user corresponding to the user ID information, the setting information corresponding to the acquired user ID information.

According to still another aspect of the present invention, there is provided a setting information acquiring program for causing a computer execute processing for: acquiring card ID information of a user; acquiring, on the basis of the acquired card ID information, user ID information for identifying the user associated with the card ID information; and acquiring, on the basis of environment setting administrator authority for allowing the user to acquire environment setting information associated with user ID information of plural users who can be targets of acquisition of environment setting information concerning a work environment of the user corresponding to the user ID information, the environment setting information corresponding to the acquired user ID information.

### DESCRIPTION OF THE DRAWINGS

FIG. 1 is a system diagram for explaining an environment setting information acquiring system including an image processing apparatus and plural servers, according to an embodiment of the present invention;

FIG. 2 is a functional block diagram for explaining the image processing apparatus according to the embodiment;

FIG. 3 is a data table in which user IDs and environment setting information corresponding to the user IDs are associated;

FIG. 4 is a flowchart for explaining processing for acquiring information concerning environment setting to be executed by the image processing apparatus according to the embodiment;

FIG. 5 is a diagram of a standby state screen displayed on a display unit before authentication processing by a card is started;

FIG. 6 is a diagram of a screen displayed on the display unit in a state in which a work environment peculiar to a user is reflected on the image processing apparatus; and

FIG. 7 is a diagram of a screen displayed when “Scan to file” is selected in the screen shown in FIG. 6.

### DETAILED DESCRIPTION

An embodiment of the present invention is explained below with reference to the accompanying drawings.

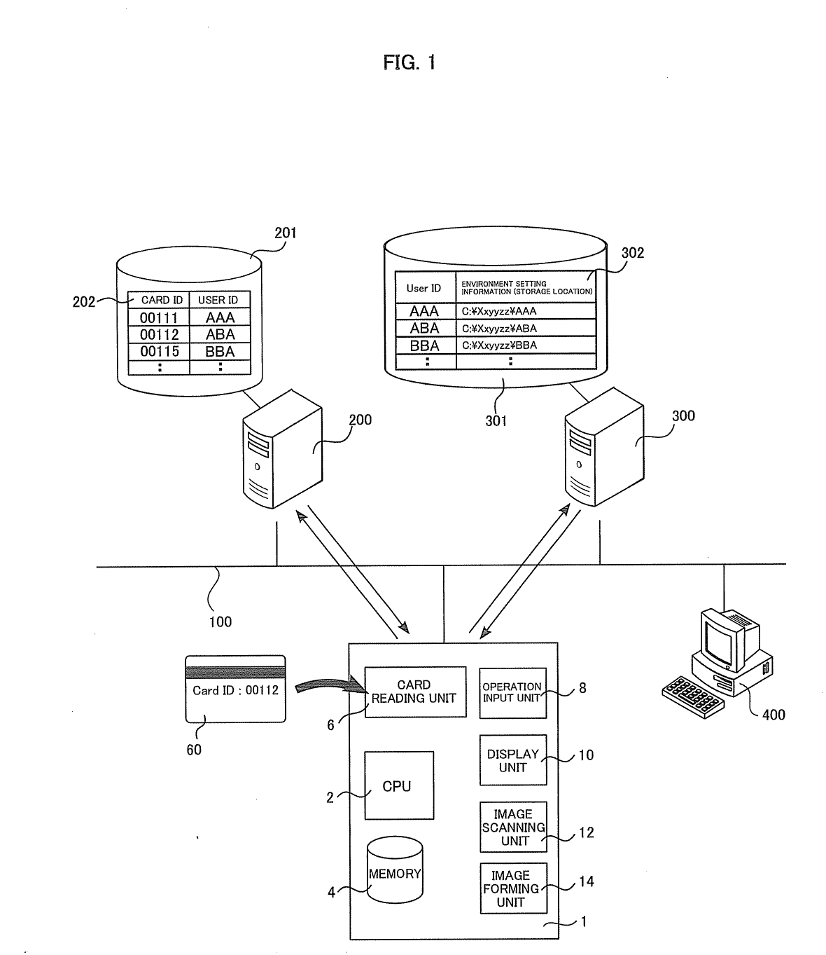

FIG. 1 is a system diagram for explaining a system including an image processing apparatus and servers connected to the image processing apparatus via a network, according to this embodiment.

The system shown in FIG. 1 includes an image processing apparatus 1 as a multi function peripheral (MFP) that has plural functions such as printer, scanner, and facsimile functions, a card information server 200, and an environment setting information server 300. The image processing apparatus 1, the card information server 200, the environment setting information server 300, and a personal computer 400 are connected by a network 100. The network 100 can be realized by a LAN, a WAN, the Internet, or the like. The image processing apparatus 1, the card information server 200, and the environment setting information server 300 may be connected to the network 100 by either wire or radio.

With the system according to this embodiment shown in FIG. 1, it is possible to establish a system that can realize, with simple authentication by card, processing for acquiring environment setting information for specifying a work environment peculiar to a user. Since the work environment of the user can be easily invoked to the image processing apparatus 1 by using the card, it is possible to perform efficient data processing and data management using the image processing apparatus 1.

The respective apparatuses configuring the system shown in FIG. 1 are explained below.

The card information server 200 manages a card information database 201 that stores a data table 202 in which card ID information of cards used for the processing for acquiring environment setting information for specifying work environments and user ID information as identification information for specifying respective users are associated. As explained in detail later, when the card information server 200 receives a card ID transmitted from the image processing apparatus 1, the card information server 200 performs processing for retrieving a card ID coinciding with the received card ID from the card information database 201 and transmitting a user ID corresponding to the card ID to the image processing apparatus 1.

The environment setting information server 300 stores environment setting information of the respective users in association with user IDs. The environment setting information server 300 manages an environment setting information database 301 that stores a data table 302 in which user IDs and environment setting information of users having the user IDs are associated. As explained in detail later, when a user attempts to perform operation for reading a card 60 and acquire environment setting information for specifying a work environment peculiar to the user, the environment setting information server 300 performs processing for accepting an access from the image processing apparatus 1 only when the user is authenticated by authentication processing by a procedure explained later. The environment setting information server 300 searches through the environment setting information database 301 on the basis of a request from the image processing apparatus 1 and transmits environment setting information stored in a storage location of environment setting information corresponding to a user ID of the user to the image processing apparatus 1.

The work environment peculiar to the user is a condition for using the image processing apparatus 1 that can be set for each of the users. When the work environment peculiar to the user is created from the image processing apparatus 1 and a personal computer or the like connected to the image processing apparatus 1 via the network, if the work environment is invoked to the image processing apparatus 1, it is possible to use the image processing apparatus 1 with the set condition reflected thereon. Details of contents that can be specified as the work environment are explained later. For example, it is possible to designate a directory at a storage destination in which data scanned by the image processing apparatus 1 is stored. In this case, the user can store, simply by invoking the work environment of the user, the scan data in the designated directory without inputting the storage destination again. The environment setting information is a set of specific setting information for establishing the work environment peculiar to the user. For example, when a storage destination of data is designated, a directory indicating the storage destination configures one piece of environment setting information.

The image processing apparatus 1 is a multi function peripheral (MFP) as explained above. The image processing apparatus 1 as the MFP has plural functions such as copying, scanning, facsimile, and printer functions. Further, when the image processing apparatus 1 is connected to other servers and personal computers by a network, the image processing apparatus 1 can transmit a scanned image to the servers and the like and stores the image therein (scan to file) and print data stored in the servers and the like.

The image processing apparatus 1 includes a CPU 2 that controls various kinds of processing in the image processing apparatus 1, a memory 4 that stores programs, data, and the like, a card reading unit 6 that reads information recorded in a card, an operation input unit 8 for performing various kinds of operation for the image processing apparatus 1, a display unit 10 that displays various kinds of information such as conditions for printing and a storage destination of scan data, an image scanning unit 12 that performs scanning of an image during copying and scanning, and an image forming unit 14 that performs printing of a copied image and data and the like transmitted from a personal computer via a network.

The CPU 2 controls various kinds of processing in the image processing apparatus 1. Further, in this embodiment, the CPU 2 executes processing concerning acquisition of environment setting information for specifying a work environment peculiar to a user. As explained above, the CPU 2 can executes the various programs stored in the memory 4.

The memory 4 stores programs used for image processing in the image processing apparatus 1. As explained later, the memory 4 stores environment setting administrator information as information necessary for authentication processing performed when the work environment is invoked. The memory 4 can include, for example, a RAM (Random Access Memory), a ROM (Read Only Memory), a DRAM (Dynamic Random Access Memory), an SRAM (Static Random Access Memory), or a VRAM (Video RAM).

The card reading unit 6 performs reading of card ID information peculiar to each card recorded in the card 60 and necessary for acquiring the environment setting information in the image processing apparatus 1 according to this embodiment. As the card 60, for example, a magnetic card or an IC card can be used. A configuration of the card reading unit 6 can be changed according to a type of a card in use. When plural kinds of cards are used, plural reading devices may be provided according to the types of the cards. The card reading unit 6 can include an inserting-type card reader in which a card is inserted in an insertion hole or a slide-type card reader in which a card is inserted from one end of a slit to the other end. When an IC card embedded with an IC chip is used as a card, the card reading unit 6 can also include a non-contact type card reader by an RFID (Radio Frequency Identification) technique for holding the card over a reading unit to read information.

The operation input unit 8 is a unit for performing operation for designating conditions for copying and scanning and inputting a facsimile number. The operation input unit 8 can include, for example, input keys for numbers and the like, a keyboard, a mouse, a touch panel, a touch pad, or a graphic tablet.

The display unit 10 displays various kinds of information such as setting information and an operation state of the image processing apparatus 1. When environment setting information is acquired by processing explained later and a work environment peculiar to a user is realized, the display unit 10 can perform display corresponding to the work environment. The display unit 10 can include, for example, an LCD (Liquid Crystal Display), an EL (Electronic Luminescence) display, a PDP (Plasma Display Panel), or a CRT (Cathode Ray Tube). If the display unit 10 includes a touch panel display, the display unit 10 can also realize a part or all of the functions of the operation input unit 8.

The image reading unit 12 is a general image scanning device provided in a copying machine, an image scanner, and the like. The image reading unit 12 is used when copying is performed and an image and the like printed on paper and the like are scanned by using the image processing apparatus 1.

The image forming unit 14 forms an image on a sheet such as a copy sheet, thick paper, or an OHP film on the basis of image data scanned from an original document by the image scanning unit 12 or image data acquired from a memory card or an external apparatus.

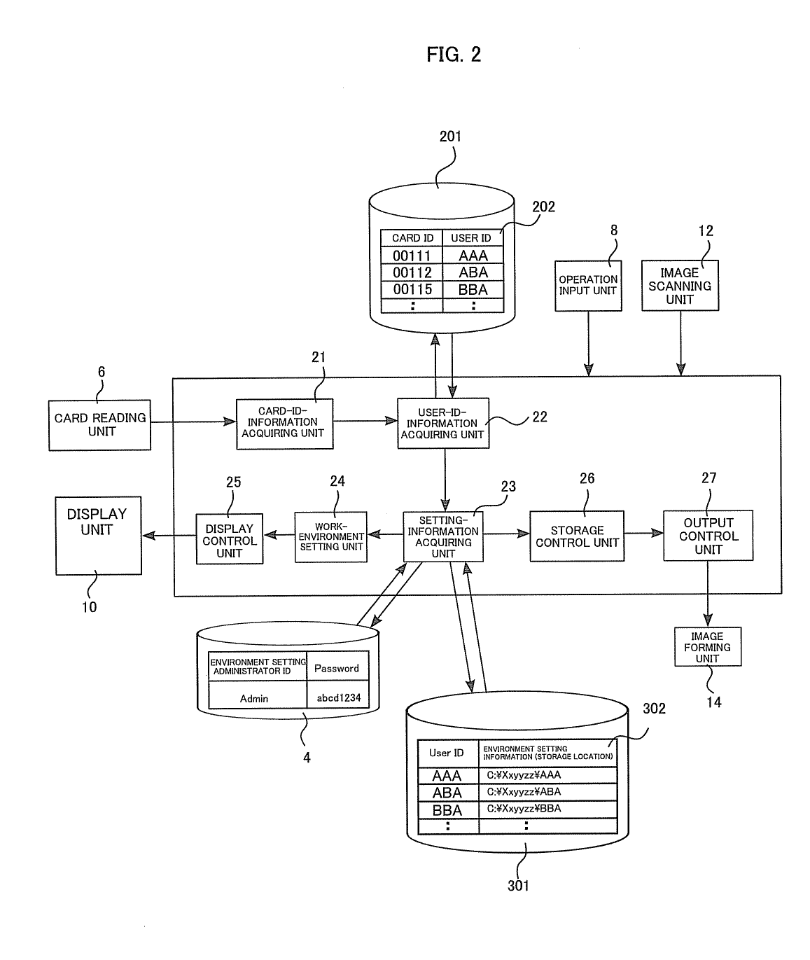

Details of the processing for acquiring environment setting information are explained with reference to FIG. 2. FIG. 2 is a functional block diagram for explaining the image processing apparatus 1 according to this embodiment.

The image processing apparatus 1 according to this embodiment includes a card-ID-information acquiring unit 21, a user-ID-information acquiring unit 22, a setting-information acquiring unit 23, a work-environment setting unit 24, a display control unit 25, a storage control unit 26, and an output control unit 27.

Details of the respective functions configuring the image processing apparatus 1 according to this embodiment are explained below.

First, the card-ID-information acquiring unit 21 acquires a card ID of the card 60 read by the card reading unit 6.

The user-ID-information acquiring unit 22 transmits a command for requesting a user ID corresponding to the card ID acquired by the card-ID-information acquiring unit 21 to the card information server 200 via the network 100. The user-ID-information acquiring unit 22 acquires the user ID corresponding to the transmitted command from the card information database 201 stored in the card information server 200.

Subsequently, the setting-information acquiring unit 23 acquires the user ID from the user-ID-information acquiring unit 22. The setting-information acquiring unit 23 acquires, from the memory 4, an ID (in FIG. 2, the ID is represented as “Admin” as an example) and a password (“abcd1234”) of an environment setting administrator having an environment setting administrator authority stored in advance. The setting-information acquiring unit 23 is authenticated on the basis of the acquired environment setting administrator ID and password and logs in to the environment setting information server 300 as the environment setting administrator. After logging in to the server 300 as the environment setting administrator, the setting-information acquiring unit 23 transmits a command for requesting environment setting information corresponding to the acquired user ID to the environment setting information server 300. The environment setting information server 300 searches through the environment setting information database 301 and transmits the environment setting information corresponding to the user ID to the image processing apparatus 1. The setting-information acquiring unit 23 acquires the environment setting information corresponding to the user ID.

According to the processing executed by the respective functions, the image processing apparatus 1 can acquire, from the card ID of the card 60, the environment setting information associated with the user ID corresponding to the card ID.

The work-environment setting unit 24 sets a work environment of the user in the image processing apparatus 1 on the basis of the environment setting information acquired by the setting-information acquiring unit 23. Since the work environment is set, the user can use the image processing apparatus 1 under conditions set as the environment setting information in advance.

What is characteristic to this embodiment in the processing realized by the functions is that the user is authenticated and logs into the environment setting information server 300 using the “environment setting administrator authority” rather than logging in using an authority based on the user ID and acquires the environment setting information for specifying the work environment peculiar to the user.

As explained above, authentication processing by a user ID and a password may be necessary in order to invoke a work environment for a user from the environment setting information server 300. In such a case, in order to acquire the work environment simply by reading the card 60 having a card ID as card identification information, the user needs to be authenticated by the environment setting information server 300 while omitting ID input and password input by the user.

Therefore, in this embodiment, as explained above, when the user-ID-information acquiring unit 22 acquires the user ID from the card information server 200, the user logs into the environment setting information server 300 using the ID and the password of the environment setting administrator having the environment setting administrator authority registered in the memory 4 in advance instead of logging in using the user ID and the password. Since the authentication processing is performed with the environment setting administrator authority, the user does not need to input the user ID and the password, it is possible to realize the object of the present invention, i.e., the simple authentication processing with a card.

The “environment setting administrator authority” is an authority for allowing the user to acquire, using the system according to this embodiment, (all pieces of) environment setting information of plural users who can be targets of processing for acquiring, using the card 60, environment setting information for specifying work environments of the users from the environment setting information server 300. In other words, work environments (environment setting information) associated with user IDs are registered in the environment setting information server 300 in advance. The user can acquire, using the “environment setting administrator authority” instead of the user IDs, work environments of plural users, work environments peculiar to whom can be set in the image processing apparatus 1. Therefore, in general, the environment setting administrator authority is preferably an authority higher in order than individual authorities of the users registered in the environment setting information database 301 of the environment setting server 300.

The environment setting administrator authority may be, for example, an administrator authority as a highest order authority for allowing a user to freely use processing functions of the environment setting information server 300 and change setting of the respective processing functions. In that case, an ID and a password of the administrator authority are stored in the memory 4 in advance and, when the user performs processing for acquiring environment setting information using the card 60, the user transmits the stored ID and password of the administrator authority to the environment setting information server 300. In this way, the user can log in to the server 300 as an administrator rather than the user and acquire a work environment of the user.

The environment setting administrator authority may be a limited authority for allowing a user to acquire environment setting information of a certain user who is likely to acquire environment setting information by performing the authentication processing using a card according to this embodiment. If the environment setting administrator authority is the limited authority, since the highest order authority such as the administrator authority does not have to be used in this system, the system is safe in terms of security.

The “environment setting information” is, as explained above, information used for realizing a work environment peculiar to a user in the image processing apparatus 1. In other words, the environment setting information concerning a work environment is operation parameters and setup information for specifying conditions of use (a work environment) of the image processing apparatus 1 that can be set for each of users. Examples of the environment setting information may include directory information for designating a storage destination of image data treated in the image processing apparatus 1 and setting information such as conditions for printing and scanning, a facsimile number, and an email address. In the image processing apparatus 1, when the environment setting information including these kinds of information is acquired and reflected as a work environment, for example, if a directory for designating a storage destination of scan data is set, the user can store data in the directory without inputting a storage destination of the data every time scanning is performed. If the user sets frequently used conditions as conditions for printing and scanning, since a work environment is reflected, the user can perform printing and scanning under the conditions. Examples of specific conditions for printing include selection of color and monochrome, a sheet size, the direction of a sheet, and selection of simplex and duplex printing. Examples of conditions for scanning include scanning resolution, selection of color and monochrome, and a file format. When information such as a facsimile number and an email address is included as setting information, the user can transmit, by selecting a destination from the information, scanned data or the like by facsimile or email without inputting the destination.

Among the other functional blocks, when a work environment corresponding to an acquired user ID is set by the work-environment setting unit 24, the display control unit 25 performs processing for displaying a screen corresponding to the set work environment on the display unit 10. Examples of the processing include processing for displaying a registered directory as a storage destination in which a scan image is stored. If conditions for printing and scanning are included in the environment setting information, it is also possible to perform display corresponding to the conditions. Besides, it is possible to reflect visual setting such as a color, arrangement, and the like of a screen. An example of an actual screen displayed on the display unit 10 is explained later.

The storage control unit 26 performs processing for storing image data and the like, which are scanned by the image scanning unit 12 of the image processing apparatus 1, in servers and personal computers on the network 100 or a recording medium connected to the image processing apparatus 1. For example, in this embodiment, when a work environment is set by login processing and data is set to be stored in a directory designated by the user in advance, the storage control unit 26 performs control to store the data in a storage area designate by the directory. If a directory for data storage is created in the environment setting information server 300 as a storage destination of the data, the data can be stored in association with a user ID together with environment setting information. As shown in FIG. 1, it is also possible to store the data designating a specific directory of the external personal computer (or server) 400 or the like connected to the image processing apparatus 1 by the network 100.

The storage control unit 26 can also perform, according to operation of the operation input unit 8 by the user or an instruction from a personal computer or the like of the user on the network 100, processing for reading out image data stored in advance to the image processing apparatus 1 in order to, for example, print the image data using the image forming unit 14. When data is read out and printed, data can also be read out from all servers and personal computers connected to the image processing apparatus 1 via the network 100. Further, data can be read out from a USB memory and a memory card connected to the image processing apparatus 1.

The read-out data is transmitted to the image forming unit 14 by the output control unit 27. As explained above, the image forming unit 14 forms an image on a sheet such as paper.

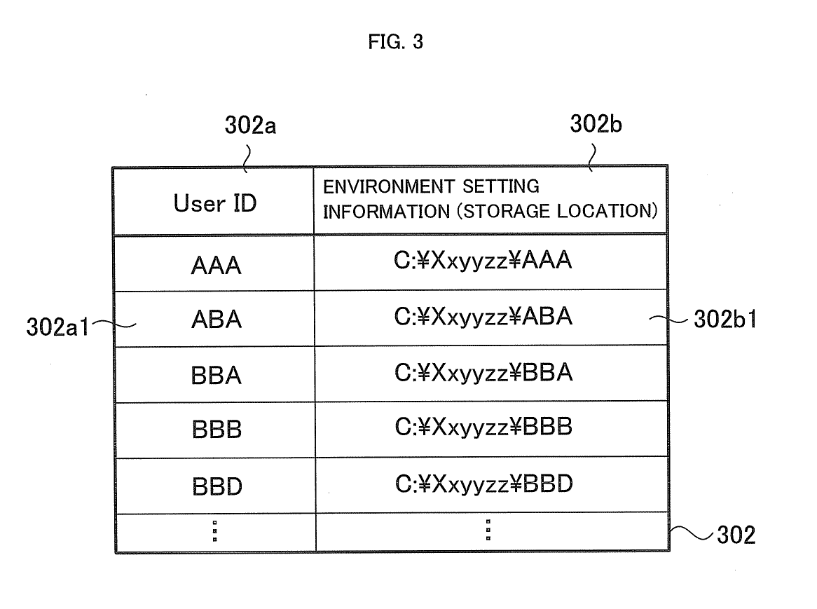

The structure of the data table 302 stored in the environment setting information database 301 shown in FIGS. 1 and 2 is explained with reference to FIG. 3. As shown in FIG. 3, in the data table 302, user IDs, environment setting information for which is stored in the server 300, are arranged in a column 302a of User ID, locations (directories) where the environment setting information corresponding to the user IDs is stored are arranged in a column 302b of environment setting information, and the user IDs and the environment setting information adjacent to each other are associated. For example, a user ID “ABA” (302a1) is associated with a directory “C:¥Xxyyzz¥ABA” (302b1).

Therefore, for example, when the server 300 is requested by the image processing apparatus 1 to transmit environment setting information for the user ID “ABA” (302a1), it is seen from the data table 302 that the environment setting information corresponding to the user ID “ABA” is stored in a directory (a folder) specified by “C:¥Xxyyzz¥ABA” of the environment setting information server 300. Consequently, the environment setting information server 300 can read out the environment setting information stored in the directory “C:¥Xxyyzz¥ABA” and transmit the environment setting information to the image processing apparatus 1.

With the system including the image processing apparatus 1 according to this embodiment, when the system performs the processing for reading the card ID of the card 60, the system can perform authentication processing in the server 300 on behalf of the user using the environment setting administrator authority recorded in the image processing apparatus 1 in advance and acquire environment setting information for specifying a work environment. Therefore, the user only has to perform operation for reading the card 60 in order to set a work environment of the user in the image processing apparatus 1. The user does not need to input the user ID and the password. Therefore, with this system, the user can easily and quickly set the work environment of the user in the image processing apparatus 1. Efficiency of work such as capturing, printing, and the like of data is improved. This system simply performs authentication processing using a card. However, since an ID and a password are necessary for login to the environment setting information server 300, security of the server 300 can be maintained.

A flow of processing for acquiring environment setting information in order to set a work environment peculiar to a user and processing for setting the work environment of the user on the basis of the acquired environment setting information in the image processing apparatus 1 according to this embodiment is explained.

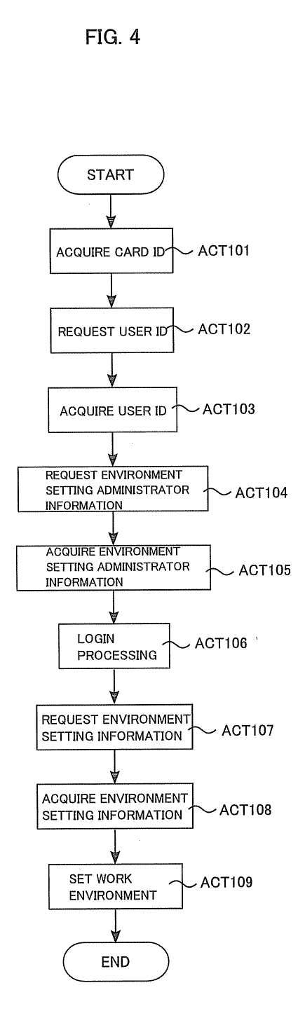

FIG. 4 is a flowchart of an example of a flow of processing (an environment setting information acquiring method) executed by the image processing apparatus 1 according to this embodiment.

First, the card-ID-information acquiring unit 21 acquires a card ID when a card is read by the card reading unit 6 (ACT 101). For example, if a card ID of the card 60 is “00112”, the card-ID-acquiring unit 21 acquires the card ID as “00112” when the card is read by the card reading unit 6 as shown in FIG. 1 and FIG. 2.

Subsequently, the user-ID-information acquiring unit 22 transmits a command for requesting a user ID corresponding to the acquired card ID to the card information server 200 via the network 100 (ACT 102).

The card information server 200 retrieves the card ID corresponding to the transmitted command from the card information database 201 and transmits a card ID associated with the card ID to the image processing apparatus 1. The user-ID-information acquiring unit 22 acquires a user ID corresponding to the transmitted card ID (ACT 103). When the card ID is “00112”, the card information server 200 shown in FIG. 1 retrieves a card ID “00112” from the card information database 201 and transmits a user ID “ABA” corresponding to the card ID to the image processing apparatus 1.

When the user-ID-information acquiring unit 22 acquires the user ID corresponding to the transmitted card ID, the setting-information acquiring unit 23 requests the memory 4 to send an environment setting administrator ID and a password (ACT 104). For example, as shown in FIG. 2, the setting-information acquiring unit 23 acquires an environment setting administrator ID “Admin” and a password “abcd1234” (ACT 105).

When the setting-information acquiring unit 23 acquires the environment setting administrator ID and the password, the setting-information acquiring unit 23 accesses the environment setting information server 300. Instead of the authentication processing by the user ID and the password, the setting-information acquiring unit 23 is authenticated in order to log in to the server 300 using an environment setting administrator authority higher in order than individual user authorities (ACT 106). Specifically, the setting-information acquiring unit 23 performs processing for transmitting the environment setting administrator ID and the password to the environment setting information server 300. If the transmitted ID and password coincide with an ID and a password stored as environment setting administrator information in the environment setting information server 300, the authentication is allowed and the login is successful.

When the login is successful, the setting-information acquiring unit 23 transmits a command for requesting environment setting information of the user (ACT 107). The command for requesting environment setting information only has to be a command that includes the user ID acquired from the card information database 201 and with which the environment setting information server 300 that receives the command can identify which user requests the environment setting information.

When the environment setting information server 300 receives the command, the environment setting information server 300 retrieves the requested user ID from the environment setting information database 301 and transmits environment setting information associated with the user ID to the image processing apparatus 1. As explained above, in this embodiment, in the data table 302 of the environment setting information database 301, user IDs and storage locations of environment setting information corresponding to the user IDs are arranged in association with each other. Therefore, actually, when the environment setting information server 300 receives the command, the environment setting information server 300 specifies a storage location of environment setting information corresponding thereto from the data table 302, reads out the environment setting information from the storage location, and transmits the environment setting information to the image processing apparatus 1. For example, when the environment setting information server 300 receives a command for requesting environment setting information of a user ID “ABA”, the environment setting information server 300 specifies a storage location “C:¥Xxyyzz¥ABA” of environment setting information corresponding thereto, and transmits the environment setting information of the user ID “ABA” from the storage location to the image processing apparatus 1.

Consequently, the setting-information acquiring unit 23 acquires the environment setting information corresponding to the user ID (ACT 108).

When setting contents of a work environment of the user is reflected on the image processing apparatus 1, the work-environment setting unit 24 performs setting of a work environment on the basis of the acquired environment setting information (ACT 109). Further, when display corresponding to the work environment of the user is performed on the display unit 10, the display control unit 25 may perform display of a screen based on the environment setting information.

The image processing apparatus 1 according to this embodiment acquires the environment setting information with reading of the card ID as a trigger. The processing for realizing a work environment peculiar to the user in the image processing apparatus 1 is finished. Consequently, the user can use the image processing apparatus 1 in the work environment peculiar to the user.

The flow until the work environment of the user is realized in the image processing apparatus 1 on the basis of the acquired environment setting information is explained with reference to FIG. 4. However, it is also possible to finish the processing in the acquisition of the environment setting information without performing the processing for realizing the work environment of the user. When the processing is finished in the acquisition of the environment setting information peculiar to the user, the processing in ACT 109 is omitted.

When the user ID cannot be acquired because, for example, the card ID is not stored in the card information database 201 or the user ID corresponding to the card ID is not stored, the processing may be finished without performing the processing in ACT 103 and subsequent acts.

In the above explanation, when the user ID is acquired in ACT 103, the environment setting information is requested in ACT 104. However, the setting-information acquiring unit 23 may read out the environment setting administrator ID and the password from the memory 4 in advance. In that case, ACT 104 and ACT 105 are omitted. When the setting-information acquiring unit 23 acquires the user ID, the setting-information acquiring unit 23 proceeds to ACT 106, transmits the read-out environment setting administrator ID and the password, and performs the login processing.

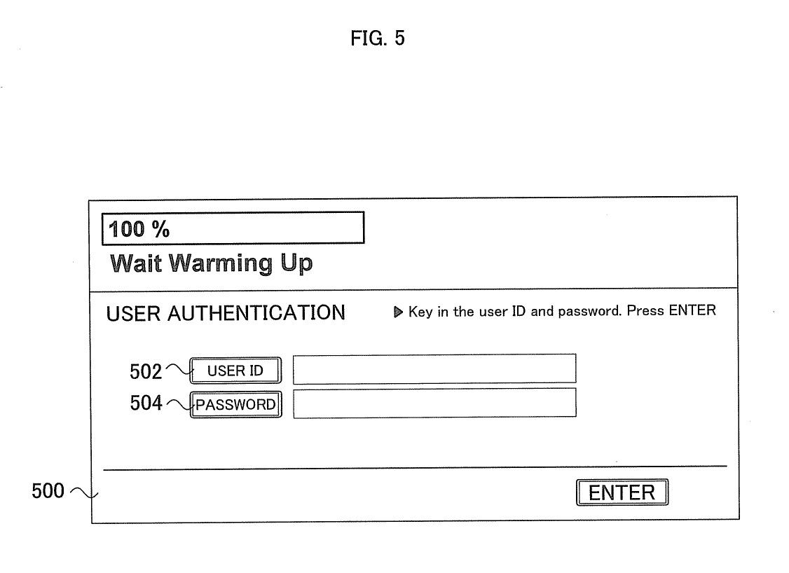

A display example of a screen displayed on the display unit 10 in the series of processing is explained with reference to FIGS. 5, 6, and 7.

FIG. 5 is a diagram of a standby screen 500 as a display screen in a standby state before the processing for acquiring environment setting information is started in ACT 101. A box 502 for inputting a user ID and a box 504 for inputting a password are displayed in the standby screen 500. Therefore, instead of the card authentication explained in this embodiment, it is also possible to perform the authentication processing by operating the operation input unit 8 to directly input the user ID and the password to the boxes 502 and 504.

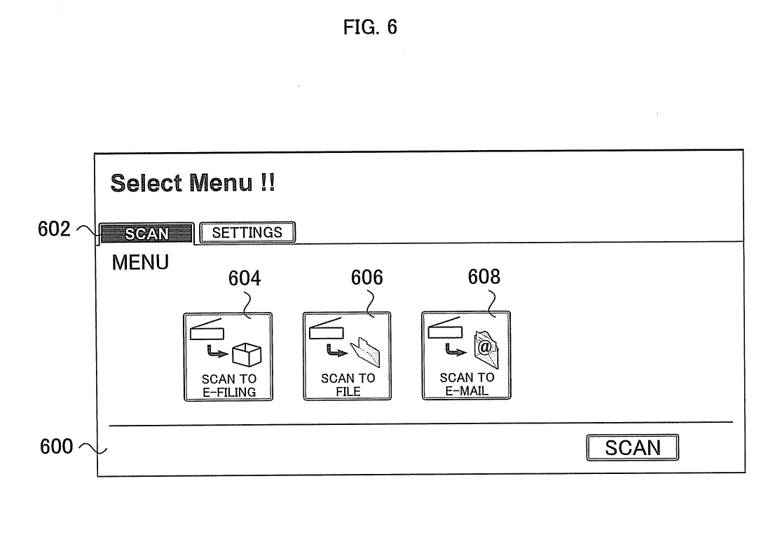

FIG. 6 is a diagram of a first scan operation screen 600 as an example of a display screen displayed when the setting-information acquiring unit 23 acquires the environment setting information in ACT 108 and the work-environment setting unit 24 sets the work environment in the image processing apparatus 1 on the basis of the acquired environment setting information in ACT 109. The first scan operation screen 600 is a screen for selecting how data obtained by scanning is processed. In the screen 600, a scan tab 602 in an upper part of the screen is selected and icons for selecting functions of Scan to E-filing, Scan to File, and Scan to E-mail are displayed. The user selects an icon 604 in executing Scan to E-filing, selects an icon 606 in executing Scan to File, and selects an icon 608 in executing Scan to E-mail. It is possible to switch the screen to a setting screen for performing various kinds of setting concerning scan operation by switching the scan tab 602 to a SETTINGS tab.

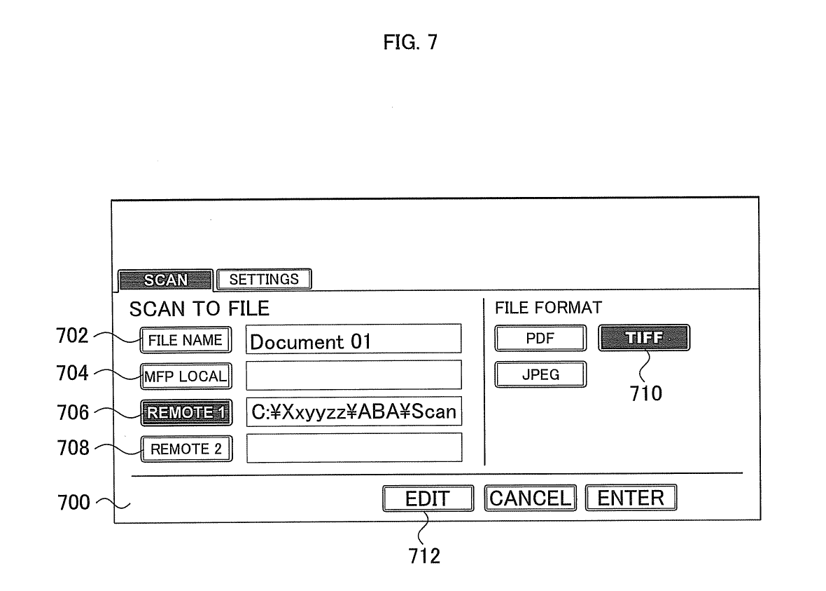

FIG. 7 is a diagram of a second scan operation screen 700 displayed when the icon 606 of Scan to File is selected in the first scan operation screen 600. In the second scan operation screen 700, the user can perform designation of a storage destination of scanned data, input or editing of a file name and a directory at the storage destination of the data, selection of a file format in storing the data, and the like.

By selecting any one of buttons 704 to 708 in the screen, the user can designate a directory displayed on the right side of the button as the storage destination of the scan data. The user selects an MFP LOCAL button 704 when the user stores data in a memory in the image processing apparatus 1. The user selects REMOTE 1 and REMOTE 2 buttons 706 and 708 when the user stores the data in an external storage area connected to the image processing apparatus 1 by a network. If the user designates in advance, as the environment setting information, a directory in which the user desires to store the data, when environment setting information is acquired and a work environment of the user is reflected on the image processing apparatus 1, the designated directory is displayed in a box of the REMOTE 1 or REMOTE 2. Therefore, in that case, the user can omit input of a storage destination.

When the user performs editing of an image processing file name and a directory, the user selects an EDIT button 712 and inputs characters in boxes on the right side of the buttons 702 to 708 of items that the user desires to edit or edits displayed characters.

The user designates a file format by selecting a button of a displayed format.

When scanning is performed in a state displayed on the screen 700 shown in FIG. 7, a file with a file name “Document 01” is stored in a TIFF format in a storage area designated by “C:¥Xxyyzz¥ABA¥Scan”. Path information “C:¥Xxyyzz¥ABA¥Scan” indicating the storage area is acquired from the directory “C:¥Xxyyzz¥ABA”.

In the screens shown in FIGS. 5 to 7, the user can perform the selection of the buttons and the character input using the operation input unit 8 of the image processing apparatus 1. If the display unit 10 is a touch panel display, the user can perform the selection of the buttons and the character input by touching a display screen.

A program for causing a computer configuring the image processing apparatus 1 to execute the acts explained above can be provided as an environment setting information acquisition program. In the example explained in this embodiment, the program for realizing the functions for carrying out the present invention is stored in advance in the storage area (the memory 4) provided in the apparatus. However, the present invention is not limited to this. The same program may be downloaded from the network 100 to the apparatus or the same program stored in a computer-readable recording medium may be installed in the apparatus. A form of the recording medium may be any form as long as the recording medium can store the program and is a computer-readable recording medium. Specifically, examples of the recording medium include internal storage devices implemented in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. Functions obtained by the installation and the download in this way may realize the functions in cooperation with an OS (operating system) in the apparatus.

The program in this embodiment includes a program for dynamically generating an execution module.

In the explanation of this embodiment, the card information database 201 is stored in the external card information server 200 connected to the image processing apparatus 1 via the network 100. However, the present invention is not limited to this. For example, the card information database 201 may be stored in a storage area in the image processing apparatus 1 such as the memory 4 in the image processing apparatus 1.

In this embodiment, the ID and the password of the environment setting administrator are transmitted to the environment setting information server 300 and the environment setting information is requested after the login processing is completed. However, the present invention is not limited to this. For example, it is also possible that the ID and the password of the environment setting administrator is transmitted to the server 300 and the command for requesting environment setting information is also transmitted to the server 300 and the login processing and the acquisition of the environment setting information are performed at the same timing.

In this embodiment, the storage location of the environment setting information is arranged in the columns 302b of the data table 302. However, the present invention is not limited to this. For example, environment setting information for realizing a work environment may be directly associated with the column 302b of the data table 302.

In this embodiment, the card ID is represented as “00111” and “00112” as an example. However, the card ID may be any information as long as the information can be recorded in a card and can distinguish the card from other cards.

In this embodiment, the storage location of the environment setting information is represented as “C:¥Xxyyzz¥ABA”. However, this representation can be appropriately changed to a representation method of a directory including “/” and “:” according to an OS.

In the explanation referring to FIGS. 5 to 7, when the work environment of the user is set, the screen for performing scan operation is displayed. However, the present invention is not limited to this. For example, the screen can be set to be a copy operation screen and a facsimile operation screen on which the work environment of the user is reflected.

The present invention has been explained in detail with reference to the specific embodiments. However, it would be obvious to those skilled in the art that various modifications and alterations can be made without departing from the spirit and the scope of the present invention.

As explained above in detail, according to the present invention, it is possible to provide a technique for allowing a user to acquire information peculiar to the user stored in a storage area, for which log-in processing and authentication processing are necessary, through simple authentication processing using a card without performing operation for inputting a user ID and a password.

What is claimed is:

1. An image processing apparatus comprising:
a card-ID-information acquiring unit that acquires card ID information of a user;
a user-ID-information acquiring unit that acquires, on the basis of the card ID information acquired by the card-ID-information acquiring unit, user ID information for identifying the user associated with the card ID information; and
a setting-information acquiring unit that acquires setting information concerning a work environment of the user corresponding to the user ID information, the setting-information acquiring unit acquiring, on the basis of administrator authority for allowing the user to acquire setting information associated with user ID information of plural users who can be targets of acquisition of the setting information, the setting information corresponding to the user ID information acquired by the user-ID-information acquiring unit.

2. The apparatus according to claim 1, wherein the setting-information acquiring unit acquires the setting information after being authenticated on the basis of an ID and a password corresponding to the administrator authority set in advance.

3. The apparatus according to claim 1, further comprising a setting unit that reflects, on the basis of the setting information acquired by the setting-information acquiring unit, setting contents concerning the work environment corresponding to the user ID information on the image processing apparatus.

4. The apparatus according to claim 1, further comprising a storage control unit that stores image data, which is acquired in the image processing apparatus, in a storage area specified in the work environment corresponding to the user ID information.

5. The apparatus according to claim 1, further comprising:
a storage control unit that reads out, on the basis of operation by the user, image data stored in a storage area specified in the work environment corresponding to the user ID information; and
an output control unit that outputs the read-out image data.

6. The apparatus according to claim 1, further comprising a display control unit that displays, on the basis of the setting information corresponding to the user ID information, a user interface screen corresponding to the work environment of the user.

7. A setting information acquiring method comprising:
acquiring card ID information of a user;
acquiring, on the basis of the acquired card ID information, user ID information for identifying the user associated with the card ID information; and
acquiring, on the basis of administrator authority for allowing the user to acquire setting information associated with user ID information of plural users who can be targets of acquisition of setting information concerning a work environment of the user corresponding to the user ID information, the setting information corresponding to the acquired user ID information.

8. The method according to claim 7, further comprising acquiring the setting information after being authenticated on the basis of an ID and a password corresponding to the administrator authority set in advance.

9. The method according to claim 7, further comprising reflecting, on the basis of the acquired setting information, setting contents concerning the work environment corresponding to the user ID information.

10. The method according to claim 7, further comprising storing image data in a storage area specified in the work environment corresponding to the user ID information.

11. The method according to claim 7, further comprising:
reading out, on the basis of operation by the user, image data stored in a storage area specified in the work environment corresponding to the user ID information; and
outputting the read-out image data.

12. The method according to claim 7, further comprising displaying, on the basis of the setting information corresponding to the user ID information, a user interface screen corresponding to the work environment of the user.

13. A setting information acquiring program for causing a computer execute processing for:
acquiring card ID information of a user;
acquiring, on the basis of the acquired card ID information, user ID information for identifying the user associated with the card ID information; and
acquiring, on the basis of environment setting administrator authority for allowing the user to acquire environment setting information associated with user ID information of plural users who can be targets of acquisition of environment setting information concerning a work environment of the user corresponding to the user ID information, the environment setting information corresponding to the acquired user ID information.

14. The program according to claim 13, further causing the computer to execute processing for acquiring the environment setting information after being authenticated on the basis of an ID and a password corresponding to the environment setting administrator authority set in advance.

15. The program according to claim 13, further causing the computer to execute processing for reflecting, on the basis of the acquired environment setting information, setting contents concerning the work environment corresponding to the user ID information on the work environment of the user.

16. The program according to claim 13, further causing the computer to execute processing for storing data in a storage area specified in the work environment corresponding to the user ID information.

17. The program according to claim 13, further causing the computer to execute processing for:
reading out, on the basis of operation by the user, data stored in a storage area specified in the work environment corresponding to the user ID information; and
outputting the read-out data.

18. The program according to claim 13, further causing the computer to execute processing for displaying, on the basis of the environment setting information corresponding to the user ID information, a user interface screen corresponding to the work environment of the user.
